(19) United States
(12) Patent Application Publication
(10) Pub. No.: US 2004/0214074 A1
(43) Pub. Date: Oct. 28, 2004

(54) Safety battery

(76) Inventors: Laurent Gaignerot, Pessac (FR); Gerard Rigobert, Fargues St Hilaire (FR); Philippe Jonac, Gradignan (FR); Vincent Bodart, Paris (FR); Jean-Louis Liegeart, D'Huison-Longueville (FR)

Correspondence Address: SUGHRUE MION, PLLC, 2100 PENNSYLVANIA AVENUE, N.W., SUITE 800, WASHINGTON, DC, 20037, US

(21) Appl. No.: 10/464,659

(22) Filed: Jun. 19, 2003

(30) Foreign Application Priority Data
Jun. 20, 2002 (FR) 02 07 630

(51) Int. Cl. H01M 2/12

(52) U.S. Cl. 429/53; 429/61

(57) ABSTRACT

The present invention provides a battery comprising at least one electrochemical cell comprising a leakproof container provided with a capsule suitable for opening in the event of excess internal pressure, and a fire-proofing safety device, the battery being characterized in that said safety device is for preventing reaction products expelled from the cell igniting in the presence of air and comprises in combination:

at least one collector means for collecting the products expelled via said capsule so as to convey them out from the battery; and

at least one spray means for spraying an agent in the form of a fluid inside said collector means, said agent enabling the temperature of said products to be lowered and preventing or quenching ignition thereof.

The present invention relates to a battery of electrochemical cells including a device for providing safety. The device comes into action when an anomaly occurs in the operation of one or more of the cells that might lead to flammable gas being given off. More particularly, the invention relates to batteries of electrochemical cells having non-aqueous electrolyte, and in particular rechargeable lithium cells of the lithium-ion type in which some of the components are flammable.

Electrochemical cells may be associated as a battery by being connected in series or in parallel. They are frequently assembled in such a manner as to form modules which are themselves mounted in a battery. The modules are usually placed together in a closed container.

An anomaly in the operation of the battery may be caused by malfunction of one of the electrochemical cells (short circuit, . . . ), or by an external disturbance (impact, high temperature, etc. . . . ). The anomaly causes the electrochemical cell to become hot and its internal pressure to increase. When the pressure becomes too great, a large volume of smoke is suddenly ejected together with incandescent particles. Contact with ambient air generally leads to large amounts of flame. The risk of such ignition is particularly large with lithium cells since they contain in particular organic solvents that evaporate easily. The proximity of a large number of cells increases the risk correspondingly.

Safety devices have been proposed which seek to put a fire out by means of an extinguishing agent which may be in the form of a gas, a liquid, a powder, granules, or indeed a mixture thereof, and placed inside the cell itself, however that disposition suffers from the drawback of increasing the total volume of a battery in proportion to the number of cells making it up. The energy density per unit volume of such a battery decreases and quickly becomes incompatible with user requirements.

In the particular case of sodium-sulfur (Na—S) primary batteries, several documents describe fire-proofing equipment serving to inject an extinguishing agent in granular form into the container of a battery via an injection nozzle engaged in the container. The fire-proofing equipment is located outside the battery. It comprises in particular a tank containing the granules of extinguishing agent and an inert gas, together with a device for pressurizing the gas contained in the tank. The tank and the device are connected to each other and to the container by a set of pipes and valves.

The time needed for such fire-proofing equipment to perform its function is long since it requires in particular a period of time to pressurize the tank by means of a gas feed device. In order to shorten this length of time, proposals have been made to keep the tank under pressure by connecting it permanently to a pressurized gas cylinder (JP-5 084 318). However gas under pressure can leak out from valves and pipework, and when a fire is detected there is no longer sufficient gas to entrain the extinguishing agent. In addition, when the tank is maintained under pressure, the powder and the granules of extinguishing agent can reach the valve seats and the connection flanges, thereby giving rise to increased amounts of leakage.

All of the devices described above share the drawback of reacting only once a fire has started, and this tardy entry into action does not ensure user safety. In particular, with a battery of rechargeable lithium cells, because of the presence of highly volatile organic solvents, the time delay can be long enough to reach a level of risk that is unacceptable. In particular, such a battery presents a high fire risk due to the products generated in the event of the reaction running away. When a battery is used in a vehicle, the consequences can be severe: fire can spread to other vehicles or to the surroundings.

An object of the present invention is to propose a battery providing better safety than in the prior art, in particular in the event of products being expelled, and in particular with respect to the risk of ignition.

The present invention provides a battery comprising at least one electrochemical cell comprising a leakproof container provided with a capsule suitable for opening in the event of excess internal pressure, and a fire-proofing safety device, the battery being characterized in that said safety device is for preventing reaction products expelled from the cell igniting in the presence of air and comprises in combination:

at least one collector means for collecting the products expelled via said capsule so as to convey them out from the battery; and

at least one spray means for spraying an agent in the form of a fluid inside said collector means, said agent enabling the temperature of said products to be lowered and preventing or quenching ignition thereof.

The collector means may be constituted by a closed space communicating firstly with said capsule and secondly with the outside of said battery.

In a variant embodiment, the collector means conveys said expelled products to a chamber having an outlet to the outside of said battery. The battery may have a plurality of collectors opening out into a common chamber. The collector means may be common to a plurality of modules, each comprising at least one electrochemical cell.

The spray means may be connected to means for storing the agent. The storage means preferably comprise a tank of fluid under pressure. The fluid may be a liquid such as water or a gas, in particular an inert gas such as nitrogen or argon. The fluid delivered by the spray means serves to stir up and cool down the collected substances sufficiently to ensure that they do not ignite when they come into the presence of air.

In another embodiment of the invention, the safety device further includes an anomaly detector. The anomaly detector preferably actuates the spray means, e.g. via mechanical means.

Other characteristics and advantages of the present invention appear on reading the following description of an embodiment given merely by way of non-limiting illustration, and from the accompanying drawing in which the sole FIGURE is a perspective view of a battery of the invention constituted by four electrochemical cell modules associated with a device of the invention.

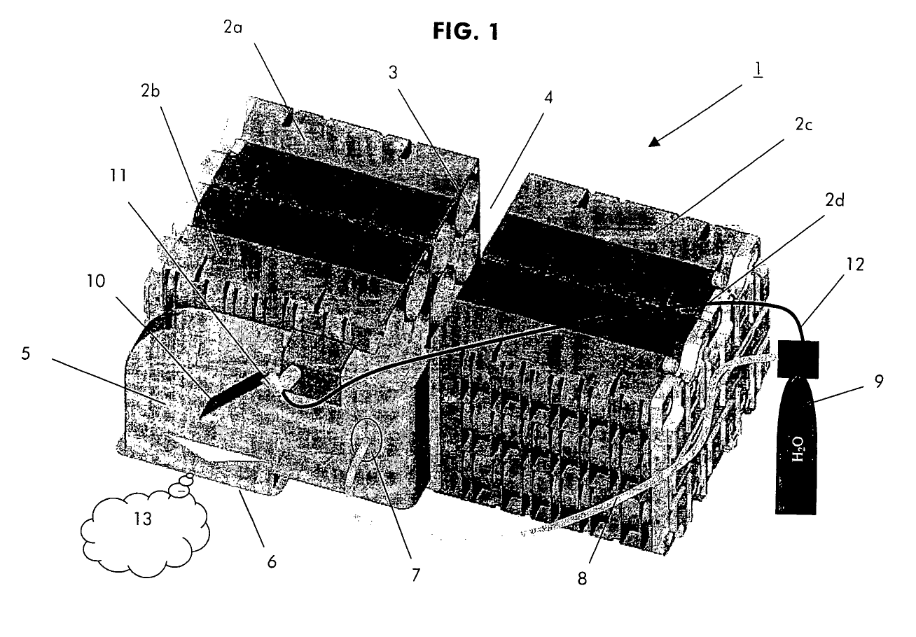

The battery 1 shown in FIG. 1 comprises four modules 2a to 2d each constituted by six cylindrical electrochemical cells 3. Each cell 3 is provided with a safety capsule for opening in the event of internal pressure becoming excessive so as to allow reaction products to escape. An empty space 4 is left between two modules. The modules are placed facing each other in such a manner that the safety capsule of each cell opens out into the space 4. The modules are enclosed in a leakproof container (not shown) which enables the reaction products expelled when a capsule opens to be collected in the space 4 which forms a closed channel. The channel 4 collects the products in order to take them to a chamber 5 including an outlet 6 leading to the outside. A spray device 7, such as a nozzle, serves to spray a fluid inside the channel 4. The spray device 7 is connected by a pipe 8 to a tank 9 of fluid under pressure, in this case a cylinder of pressurized water. Under the effect of the pressure of the products expelled into the channel 4, a valve 10 actuates an event-detector switch 11. Spraying is triggered by the switch 11 which is connected by control means 12 to the tank 9. The products ejected from the chamber 5 are cooled and are no longer in a state to ignite spontaneously on making contact with ambient air. Only smoke 13 is observed. When gas ceases to be expelled from the electrochemical cell 3, the event-detector switch 11 may cause the tank 9 to be closed via the control means 12. Thus, depending on the volume of fluid contained in the tank 9, the safety system can treat a plurality of events at different intervals.

What is claimed is:

1/ A battery comprising at least one electrochemical cell comprising a leakproof container provided with a capsule suitable for opening in the event of excess internal pressure, and a fire-proofing safety device, the battery being characterized in that said safety device is for preventing reaction products expelled from the cell igniting in the presence of air and comprises in combination:
at least one collector means for collecting the products expelled via said capsule so as to convey them out from the battery; and
at least one spray means for spraying an agent in the form of a fluid inside said collector means, said agent enabling the temperature of said products to be lowered and preventing or quenching ignition thereof.

2/ A battery according to claim 1, in which said collector means is constituted by a closed space communicating firstly with said capsule and secondly with the outside of said battery.

3/ A battery according to claim 1, in which said collector means conveys said expelled products to a chamber having an outlet to the outside of said battery.

4/ A battery according to claim 1, in which said spray means is connected to means for storing said agent.

5/ A battery according to claim 4, in which said storage means is a tank of fluid under pressure.

6/ A battery according to claim 1, further comprising an anomaly detector.

7/ A battery according to claim 6, in which said anomaly detector actuates the spray means.
